(19) United States
(12) Patent Application Publication
(10) Pub. No.: US 2002/0191566 A1
(43) Pub. Date: Dec. 19, 2002

(54) Method of cellular communication

(76) Inventor: Eliezer Fogel, Herzlia (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 09/875,033

(22) Filed: Jun. 7, 2001

(51) Int. Cl. H04B 7/216

(52) U.S. Cl. 370/335; 370/337

(57) ABSTRACT

A method for cellular communication which transmits code division multiple access (CDMA) signals of one user during a time slot allotted to that user.

### FIELD OF THE INVENTION

The present invention relates to cellular communication generally.

### BACKGROUND OF THE INVENTION

There are many forms of cellular communication each of which enables multiple mobile telephones to communicate with a single base station at the same time. Time division multiple access (TDMA) divides a period of time into multiple time slots while frequency division multiple access (FDMA) divides a bandwidth of frequencies into multiple frequency bins. Each time slot or frequency bin is allotted to a channel of communication either from the base station to a mobile or from a mobile to the base station.

Code division multiple access (CDMA) provides different modulating codes to each mobile unit and base station in a method known as “spread spectrum” modulation. The modulating codes are generally orthogonal to each other such that each element in the system can communicate on the same frequency band at the same time. CDMA systems generally enable more mobile telephones to communicate with a single base than the other types of systems.

Unfortunately, in order for the base station to separate the multiple users, the modulating codes must remain orthogonal to each other in the received signals. This does not always happen in practice. The users may not be perfectly synchronized such that their signals arrive at the base station slightly delayed from each other. Moreover, the transmitted signal of each user often moves through multiple paths before reaching the base station. As a result, separating multiple users is a complex mathematical operation.

In advanced CDMA systems, such as the 3GPP system operating in “circuit switched mode”, such as is used in speech communication, the mobile telephone usually transmits continuously towards the base station. This implies that the power amplifier, which consumes a significant amount of power, is continuously operative. This affects the battery life of the mobile station.

### BRIEF DESCRIPTION OF THE DRAWINGS

The present invention will be understood and appreciated more fully from the following detailed description taken in conjunction with the appended drawings in which:

FIG. 1 is all illustration of a method of transmitting data of different users, operative in accordance with a first embodiment of the present invention;

FIG. 2 is an illustration of portions of a transmitter useful in the embodiment of FIG. 1;

FIG. 3 is an illustration of portions of a receiver useful in the embodiment of FIG. 1; and

FIG. 4 is an illustration of a method of transmitting data of different users, operative in accordance with a second embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description which follow are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a computer system bus.

The present invention combines concepts from code division multiple access (CDMA) systems, notably the spreading and despreading concepts, with those of time division multiple access (TDMA). In the present invention, data for each mobile unit is transmitted during an allotted time slot. This enables each mobile unit to shut off the power amplifier during the time slots not allotted to it.

It is noted that each bit to be transmitted is modulated into a series of “chips”, where the larger the number of chips, the more noise immune the transmitted signal is. The term “spreading factor” (SF) indicates the number of chips per bit.

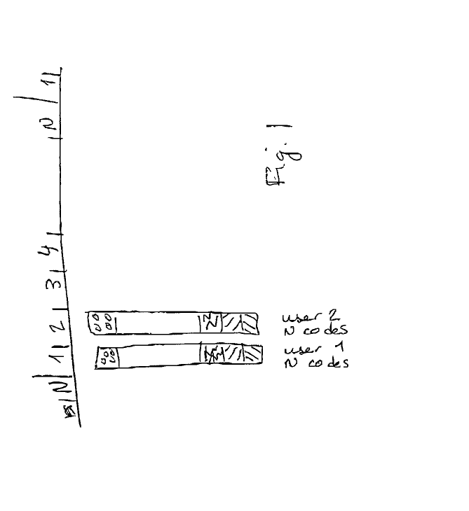

Reference is now made to FIG. 1, which illustrates the present invention. FIG. 1 shows a period T having N time slots 10 where each time slot is allocated to one user for communications between his or her mobile unit and the base station. Thus, N users/mobile units may communicate with the base station. During each time slot 10, data for the user is transmitted using the N codes, as described in more detail hereinbelow with respect to FIG. 2, rather than using only a single code of the specific user, as is common in standard CDMA systems, Thus, during time slot 1, user 1 uses all N codes to transmit his data while during time slot 2, user 2 uses all of the N codes, etc. Each user transmits during only part of period T but the transmission is of all of the data for period T and utilizes all N codes.

Reference is now made to FIG. 2, which illustrates one embodiment of a portion of a transmitter 12 of the present invention. The transmitter 12 may comprise a demultiplexer 14, multiple spreaders 16, a chip summer 18, an upconverter 17 and an amplifier 19. Demultiplexer 14 separates the data Sj to be transmitted during period T for the jth user into multiple sets Xi, each of which will be transmitted at the same time. Data Sj may be separated in any desired way, such as every M bits, every jth bit, or any other separation technique that produces suitable sets Xi.

Spreaders 16 then spread their respective set Xi with their respective code Ci to produce a modulated segment Qi. Each modulated segment Qi is typically of the length of the time slot and chip summer 18 combines the modulated segments Qi into a user signal USERj for the jth user. The combination is performed in a time-aligned manner. Thus, chip summer 18 combines the first chip of each modulated segment Qi to produce the first chip of user signal USERj, the second chip of each modulated segment Qi to produce the second clip of user signal USERj, etc. Mathematically, the process is described as follows:

Denote the bitstream input to the ith spreader by.:

{X_{i,j}: j=1 . . . k,} i=1 . . . N

and the output of the ith spreader as:

{Q_{i,j}(l): l=1 . . . SF, j=1 . . . k} i=1 . . . N

where SF is the spreading factor of the CDMA system being used and {Q_{i,j}(l): l=1 . . . SF} are the chips (whose values are +1 or −1) associated with the bit (i,j).

Chip summer 18 performs the following summation:

$${USER}_{j} ( l ) = {\sum }_{i = 1}^{N} {Q}_{i , j} ( l )$$

This user signal USERj is then transmitted during the time slot j associated with the jth user.

Upconverter 17 then converts each chip of user signal USERj (a “baseband signal”) into a radio frequency (RF) signal and amplifier 19 transits the RF signal.

It is noted tat each chip of signal USERj is the sum of the N chips at time l of the N modulated signals Qi. Thus, each chip of signal USERj has a value between {−N, +N}. To transmit such a signal requires a power amplifier having a larger dynamic range than a regular CDMA transmitter. For a mobile handset, a power amplifier with a large dynamic range utilizes more of the battery power. The present invention attempts to offset this disadvantage by shutting the power amplifier down during the timeslots not allocated to the user of the mobile handset.

It is noted that only one user transmits during a time slot. Thus, there is no need for complicated multi-user detection algorithms in the base station as only one user transmits at a time. Furthermore, there is no need for synchronizing among multiple users, for the same reason. Accordingly, the base station operation may be simplified.

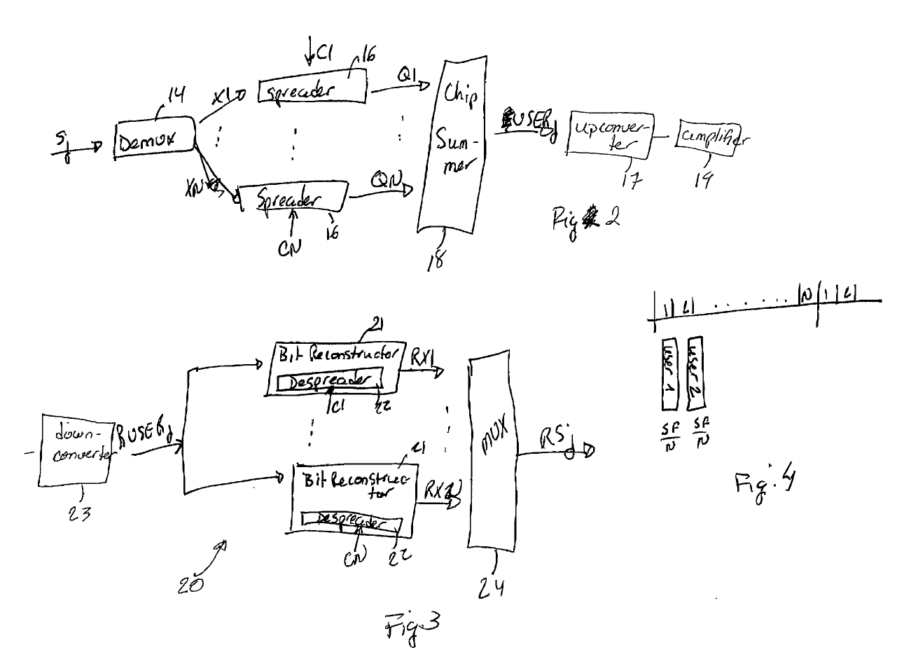

Reference is now made to FIG. 3, which generally illustrates a receiver 20 that decodes the received signal RUSERj. As in all standard receivers in a base station, receiver 20 comprises a downconverter 23 to convert the RF signal to a baseband signal and a multiplicity of bit reconstructors 21, each of which converts the baseband signal RUSERj to produce a received segment Rxi. Receiver 20 also includes a multiplexer 24 which performs the inverse operation of demultiplexer 14. It is noted that, in this embodiment, receiver 20 may be found in both the base station and the mobile handset.

A standard reconstructor 21 is a “Rake receive” which may interpret the multi-path signals forming part of RUSERj into a single set of bits and typically may include therein a despreader 22. However, the despreader 22 of each bit reconstructor 21 operates with a different one of the N codes. Thus, the first despreader 22 uses code C1 to produce a despreaded version RX1 of set X1, the second despreader 22 user code C2 to produce a despreaded version RX2 of set X2, etc. The result is a series of sets RXi that should be despreaded versions of the sets Xi.

Multiplexer 24 then combines the sets Xi to produce the received version RSj of the data signal Sj. The combination operation performed by multiplexer 24 is the “inverse” of the operation performed by demultiplexer 14 of transmitter 12. Thus, if the set Xi is the ith segment of the signal Sj, then multiplexer 24 places the set RXi as the ith segment of received signal RSj. If the set Xi contains every ith bit, then multiplexer 24 interleaves the bits from the sets RXi accordingly.

The output signal SRj is the signal for the jth user during his/her timeslot.

In an alternative embodiment of the present invention, the data rate during transmission is increased by using a lower spreading factor SF. As discussed hereinabove, the spreading factor SF indicates the number of chips per bit. Spreading codes are typically 2^{k} chips long, where k=2 to 8. Since each chip takes a timeτ to transmit, the time to send one bit is 2^{k}τ. The more chips, the stronger the noise immunity (i.e. the easier it is to despread accurately). In situations of a clean environment, the noise problems are reduced, so, in 3GPP systems the base station indicates to the mobile unit to use a lower spreading factor SF (i.e. to reduce k). This enables more bits to be transferred during any given time period.

In accordance with another embodiment of the present invention, a lowered SF may be used to provide timeslots to multiple users. With the lowered SF, each bit is transmitted in less time (since transmission is SF*τ). Thus, the same X bits of information can be transmitted in less time. If K=k/N, then N users can transmit X bits during the same time that it takes the one user to transmit the X bits when K=k. Thus, in accordance with an embodiment of the present invention, when the SF is reduced by a factor of N, N timeslots are created and each user transmits during its own timeslot, but with the lower SF.

Reference is now made to FIG. 4, which illustrates the alternative embodiment. FIG. 4 shows a time period T having N time slots. In each time slot, a different user or group of users transmits. However, in this embodiment, each user transmits using a spreading factor which is lower, by N, than that which is standard. The result is that each user finishes transmission in the time T/N. Accordingly, there can be N groups of users and N time slots.

As is known in 3GPP base stations, the spreading factor may be determined as a function of bit error rate and channel quality, where channel quality may be measured by signal strength, number of paths by which a signal arrives at a receiver, the fading rate, etc. For example, given a measured channel quality and a desired bit error rate, a 3GPP base station includes algorithms to deduce minimum chip rate and to select the resultant spreading factor. In accordance with an embodiment of the present invention, the base station may also determine the number of users N that can be supported by the lowered spreading factor.

It will be appreciated that each time slot can have a single user, operating with his own low spreading for, or multiple users, each transmitting with their own lowered spreading factor and their own codes as long as the spreading factors are chosen to maintain orthogonal codes.

The methods and apparatus disclosed herein have been described without reference to specific hardware or software. Rather, the methods and apparatus have been described in a manner sufficient to enable persons of ordinary skill in the art to readily adapt commercially available hardware and software as may be needed to reduce any of the embodiments of the present invention to practice without undue experimentation and using conventional techniques.

It will be appreciated by persons skilled in the art that the present invention is not limited by what has been particularly shown and described herein above. Rather the scope of the invention is defined by the claims that follow:

1. A method for cellular communication comprising:
transmitting code division multiple access (CDMA) signals of one user during a time slot allotted to said user.

2. A method according to claim 1 and also comprising spreading the data of said user to be transmitted during said time slot with more than one spreading code.

3. A method according to claim 1 wherein there are N spreading codes and wherein said transmitting comprises transmitting using a dynamic range of {−N,N}.

4. A method according to claim 1 and also comprising having a predetermined spreading factor and spreading the data of said user to be transmitted during said time slot with a spreading factor less than said predetermined spreading factor.

5. A cellular communication time period having multiple timeslots wherein each timeslot is allotted to one of a multiplicity of users and wherein information to be transmitted during said timeslot is encoded using codes assigned to at least two of said multiplicity of users.

6. A time period according to claim 5 and also comprising a predetermined spreading factor wherein said information is spread with a spreading factor less than said predetermined spreading factor.

7. A transmitter comprising:
a demultiplexer adapted to divide an input signal into a plurality N of sets of data;
a multiplicity N of spreaders each adapted to spread an associated one of said plurality of sets using an associated one of N spreading codes to produce N modulated segments; and
a summer adapted to sum said N modulated segments in a time aligned manner.

8. A transmitter according to claim 7 and also comprising a predetermined spreading factor defining the length of said spreading codes and a spreading factor changer for reducing said spreading factor to less than said predetermined spreading factor.

9. A transmitter comprising:
a demultiplexer adapted to divide an input signal into a plurality N of sets of data;
a multiplicity N of spreaders each adapted to spread an associated one of said plurality of sets using an associated one of N spreading codes to produce N modulated segments;
a summer adapted to sum said N modulated segments in a time aligned manner; and
an upconverter adapted to convert the output of said summer into radio frequency signals.

10. A receiver comprising:
a multiplicity N of bit reconstructors each adapted to use one of N despreading codes to produce N demodulated segments from a received signal; and
a multiplexer adapted to sum said demodulated segments into a received signal.

11. A receiver comprising:
a downconverter adapted to convert a received radio frequency signal to a baseband signal;
a multiplicity N of bit reconstructors each adapted to use one of N despreading codes to produce N demodulated segments from said baseband signal; and
a multiplexer adapted to sum said demodulated segments into a received signal.
